(19) United States
(12) Patent Application Publication
(10) Pub. No.: US 2026/0331960 A1
(43) Pub. Date: Oct. 22, 2026

(54) ULTRASONIC-BASED WIRELESS POWER TRANSMISSION DEVICE

(71) Applicant: DAEGU GYEONGBUK INSTITUTE OF SCIENCE AND TECHNOLOGY, Daegu (KR)

(72) Inventors: Jin Ho CHANG, Seoul (KR); Sung Woo KANG, Daejeon (KR)

(21) Appl. No.: 19/105,870

(22) PCT Filed: May 30, 2023
(86) PCT No.: PCT/KR2023/007344

§ 371 Date: Feb. 24, 2025

(30) Foreign Application Priority Data
Sep. 19, 2022 (KR) 10-2022-0118144

(51) Int. Cl. H02J 50/15; B06B 1/02; H02J 50/90

(52) U.S. Cl. CPC H02J 50/15; B06B 1/0223; H02J 50/90

(57) ABSTRACT

An ultrasonic-based wireless power transmission system according to an embodiment of the present disclosure may comprise: a transmission transducer for receiving an electrical signal to generate transmission ultrasonic waves; and a reception transducer for receiving transmission ultrasonic waves generated by the transmission transducer and converting same into an electrical signal, wherein a conversion element of the reception transducer has a receiving plane where a receiving surface facing against the transmission transducer is a plane, and the receiving plane has a shape corresponding to a shape of a beam profile generated by the transmission transducer at a focusing point.

### TECHNICAL FIELD

The present disclosure relates to a wireless power transmission device, and more specifically, to a wireless power transmission device adopting a transducer that efficiently transmits or receives wireless power based on ultrasonic waves.

### BACKGROUND ART

Wireless power transmission is a technology for transmitting electric energy from an energy source to a reception device without using wires. Representative wireless power transmission technologies include technologies for transmitting power using electromagnetic induction or radio frequency.

However, it is difficult to use conventional methods based on electromagnetic induction or radio frequency for medical devices such as implantable medical devices, pacemakers, and drug delivery systems, and thus the devices rely on surgery for battery replacement. For example, electromagnetic induction has a short charging distance and may affect the body due to heat generation issues during charging, and methods using radio frequency may cause interference with frequencies of wireless communication such as Wi-Fi or Bluetooth.

In this regard, there is technology such as prior art 1 that uses ultrasonic waves as an energy transmission medium as another conventional wireless power transmission method. In order to use ultrasonic waves as an energy transmission medium, the problem of low power transmission efficiency between ultrasonic transmission and reception devices needs to be solved, but prior art 1 and conventional technologies focus only on an optimal distance between ultrasonic transmission and reception devices or a direction in which ultrasonic waves are radiated, and do not consider the shape and size of an ultrasonic transducer (transmission transducer or a reception transducer) for improving power transmission efficiency.

### DISCLOSURE

### Technical Problem

An embodiment of the present disclosure provides a device for wirelessly transmitting power based on ultrasonic waves.

An embodiment of the present disclosure provides a wireless power transmission device having an efficient ultrasonic transducer size and shape for wirelessly transmitting power based on ultrasonic waves.

An embodiment of the present disclosure provides a transmission/reception transducer having optimal efficiency without wasting transmission energy based on ultrasonic waves.

### Technical Solution

An ultrasonic-based power transmission system according to an embodiment of the present disclosure includes a transmission transducer configured to receive an electrical signal and generate transmission ultrasonic waves, and a reception transducer configured to receive the transmission ultrasonic waves generated by the transmission transducer and convert the transmission ultrasonic waves into an electrical signal, wherein a conversion element of the reception transducer has a receiving plane where a receiving surface facing the transmission transducer is a plane, and the receiving plane may have a shape corresponding to a shape of a beam profile generated at a focusing point by a sound field generated by the transmission transducer. In an embodiment, the receiving plane of the conversion element of the reception transducer may have a shape in which a lateral length is greater than an elevation length.

An ultrasonic-based power reception device according to an embodiment of the present disclosure includes a reception transducer configured to receive transmission ultrasonic waves generated by a transmission transducer configured to receive an electrical signal and generate the transmission ultrasonic waves, and convert the transmission ultrasonic waves into an electrical signal, and a charging circuit configured to charge a battery based on the electrical signal, wherein a conversion element of the reception transducer has a receiving plane where a receiving surface facing the transmission transducer is a plane, and the receiving plane may have a shape corresponding to a shape of a beam profile generated by the transmission transducer at a focusing point.

### Advantageous Effects

The ultrasonic-based power transmission system according to an embodiment of the present disclosure can improve the efficiency of ultrasonic-based power transmission.

The ultrasonic-based power transmission system according to an embodiment of the present disclosure can contribute to improvement of the health of patients by enabling charging of implantable devices to avoid surgery for battery replacement.

### DESCRIPTION OF DRAWINGS

FIG. 1 (a) and (b) are diagrams schematically illustrating a propagation pattern of transmission ultrasonic waves from a transmission transducer of an ultrasonic-based power transmission device according to an embodiment of the present disclosure on the basis of beam intensities in lateral and elevation directions.

FIG. 2 is a perspective view illustrating the shapes of a transmission transducer and a reception transducer of an ultrasonic-based power transmission system according to an embodiment of the present disclosure.

FIG. 3 is a block diagram illustrating a configuration of an ultrasonic-based power transmission device according to an embodiment of the present disclosure.

FIG. 4 is a block diagram illustrating a configuration of an ultrasonic-based power reception device according to an embodiment of the present disclosure.

FIG. 5 to FIG. 10 are diagrams illustrating experimental results of the ultrasonic-based power transmission system according to an embodiment of the present disclosure.

### MODE FOR INVENTION

Hereinafter, reference will be made in detail to exemplary embodiments of the present disclosure, examples of which are illustrated in the accompanying drawings and described below, and wherever possible, the same or similar elements will be denoted by the same reference numerals even though they are depicted in different drawings and a redundant description thereof will thus be omitted. In the following description of the embodiments, suffixes, such as “module”, and “part”, are provided or used interchangeably merely in consideration of ease in statement of the specification, and do not have meanings or functions distinguished from one another. In the following description of the embodiments of the present disclosure, a detailed description of known functions and configurations incorporated herein will be omitted when it may make the subject matter of the present disclosure rather unclear. Further, the accompanying drawings will be exemplarily given to describe the embodiments of the present disclosure, and should not be construed as being limited to the embodiments set forth herein, and it will be understood that the embodiments of the present disclosure are provided only to completely disclose the disclosure and cover modifications, equivalents or alternatives which come within the scope and technical range of the disclosure.

In the following description of the embodiments, terms, such as “first” and “second”, are used only to describe various elements, and these elements should not be construed as being limited by these terms. These terms are used only to distinguish one element from other elements.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present.

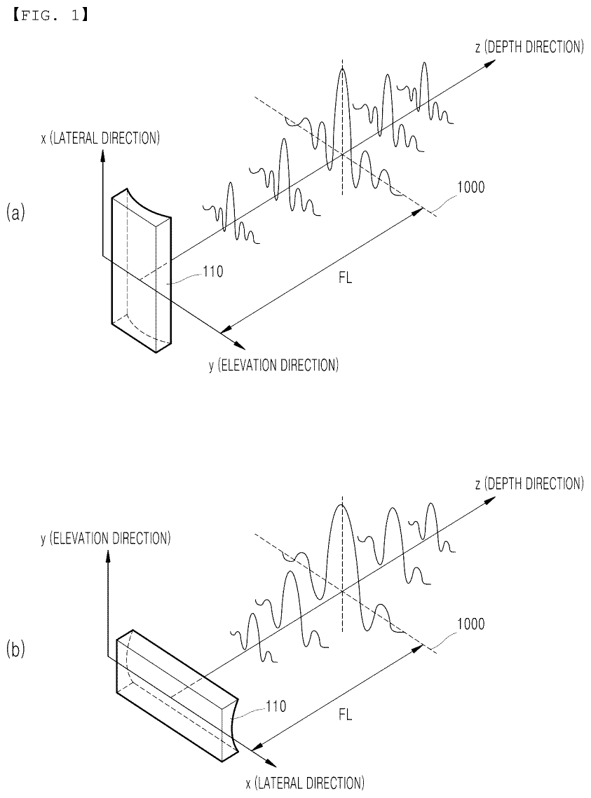

An ultrasonic-based wireless power transmission device 100 according to an embodiment of the present disclosure will be described with reference to FIG. 1.

FIG. 1(a) schematically illustrates the lateral intensity of a beam profile generated by a transmission transducer 110, and FIG. 1(b) schematically illustrates the elevation intensity of an ultrasonic beam profile generated by the transmission transducer 110. It can be confirmed that the ultrasonic beam profiles based on two axes have similar shapes although their sizes and widths are different in the axial directions.

The wireless power transmission device 100 according to an embodiment of the present disclosure includes the transmission transducer 110 that applies an electrical signal to generate transmission ultrasonic waves. The transmission ultrasonic waves generated from the transmission transducer 110 are transmitted to a wireless power reception device 200 through a medium layer.

A conversion element of the transmission transducer 110 may be defined in a depth direction, which is a direction in which the generated transmission ultrasonic waves are propagated and focused, and lateral and elevation directions forming the axis of the plane perpendicular to the depth direction.

In an embodiment, the depth direction surface of the conversion element of the transmission transducer 110 may have a concave shape in the depth direction as illustrated in FIG. 1. In another embodiment, the depth direction surface may have a flat shape, unlike FIG. 1.

The transmission ultrasonic waves generated from the transmission transducer 110 have a beam profile in the form of a sinc function in which the shape of the transmission transducer is spatially Fourier-transformed near a focusing point, and exhibits the largest sound intensity at the focusing point (FL) 1000.

If the depth direction surface of the conversion element of the transmission transducer 110 is flat, the focusing point FL can be calculated through <Mathematical Formula 1>.

FL=D²/4*λ(λ=c/fₑ) [Mathematical Formula 1]

D is the size of the conversion element of the transmission transducer 110, c is the velocity of the medium, and f_{c} is the operating frequency of the ultrasonic waves.

On the other hand, if the depth direction surface of the conversion element of the transmission transducer 110 is a concave curved surface, the focusing point FL can be formed at the center position of the radius of curvature of the curved surface.

Therefore, the transmission transducer 110 of the wireless power transmission device 100 of the ultrasonic-based power transmission system can ascertain an expected power transmission length depending on application, and set the size and operating frequency of the conversion element of the transmission transducer 110 such that the focusing point is disposed at the ascertained power transmission length. In the case of a transmission transducer 110 having a curved conversion element, the curvature of the curve in the depth direction may be determined such that a focusing point of transmission ultrasonic waves is disposed at an expected power transmission length depending on application.

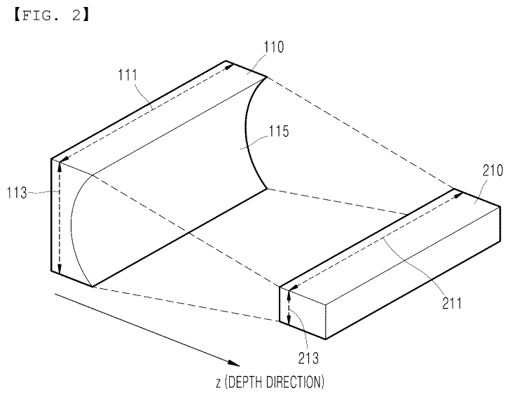

The transmission transducer 110 and a reception transducer 210 of the ultrasonic-based wireless power transmission system according to an embodiment of the present disclosure will be described with reference to FIG. 2.

In an embodiment, the conversion element of the transmission transducer 110 may be configured as a single element that is formed of a piezoelectric material, has a concave surface in the opposite direction of the reception transducer 210 along a depth axis based on an elevation-lateral plane, and has a lateral length 111 and an elevation length 113. In another embodiment, the conversion element of the transmission transducer 110 may have a one-dimensional array form in which a plurality of elements having concave surfaces in the opposite direction of the reception transducer 210 along a depth axis based on the same elevation-lateral plane is connected in the lateral direction. In this case, a time delay may be calculated such that transmission ultrasonic waves generated from each element can be focused on a focusing point to individually operate each element.

In an embodiment, the conversion element of the transmission transducer 110 may have a form in which the lateral length 111 is greater than the elevation length 113.

In an embodiment, the conversion element of the reception transducer 210 may be a single element formed of a piezoelectric material having a shape of a receiving plane, which is a receiving surface facing the sound field generated by the transmission transducer 110, and the receiving plane may have a rectangular shape in which a lateral length 211 is greater than an elevation length 213.

In an embodiment, the lateral length 211 and the elevation length 213 of the receiving plane of the conversion element of the reception transducer 210 may be equal to or less than the entire width of a main lobe formed in the lateral and elevation directions of the beam profile of the transmission ultrasonic waves generated from the transmission transducer 110 and may be equal to or greater than the width at a point of −3 dB from the highest sound pressure point of the main lobe. That is, the lateral length 211 of the receiving plane of the conversion element of the reception transducer 210 may be equal to or less than the entire width of the main lobe formed based in the lateral direction of the beam profile of the transmission ultrasonic waves generated from the transmission transducer 110, and the elevation length 213 of the receiving plane of the conversion element of the reception transducer 210 may be equal to or less than the entire width of the main lobe formed based on the elevation direction of the beam profile of the transmission ultrasonic waves generated from the transmission transducer 110. Alternatively, each of the lateral length 211 and the elevation length 213 may be equal to or greater than the width at a point of −3 dB from the highest sound pressure point of the main lobe.

That is, the conventional ultrasonic wireless power transmission technology for wireless power transmission uses a method of radiating transmission ultrasonic waves without focusing the same, and in this case, there is a problem that sufficient ultrasonic energy cannot be transmitted to the reception transducer. When the transmission ultrasonic waves are focused and used in order to solve this problem, the size of the conversion element of the reception transducer also considerably decreases, and the electrical impedance increases according to <Mathematical Formula 2>, resulting in decrease in the ultrasonic power transmission efficiency.

$$z = \frac{d}{j ωϵ A} \qquad [ Mathematical Formula 2 ]$$

Z is the electrical impedance, d is the thickness of the piezoelectric element, j is the imaginary unit, w is the angular frequency, c is the relative dielectric constant of the piezoelectric element, and A is the area of the piezoelectric element.

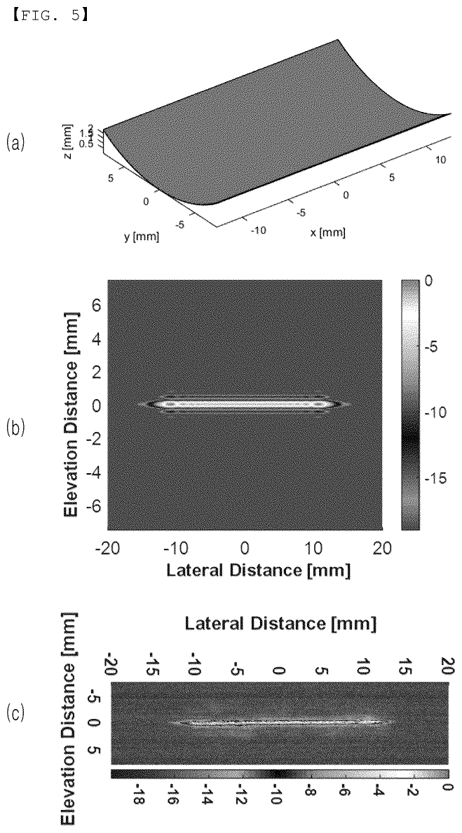

Therefore, according to an embodiment of the present invention, the receiving plane of the conversion element of the reception transducer 210 may be formed in a rectangular receiving plane shape in which the lateral length 211 is greater than the elevation length 213, and the lateral length 211 and the elevation length 213 of the conversion element of the reception transducer 210 may be set to correspond to the shape of a beam profile generated at a focusing point from the transmission transducer 110 such that an optimal electrical impedance of the reception transducer 210 can be formed. In addition, the lateral length 211 of the conversion element of the reception transducer 210 may be set, or the lateral length 111, the elevation length 113, and the curvature of a concave surface 115 in the depth-elevation direction of the transmission transducer 110 may be determined such that opposite vibrations occurring in the reception transducer 210 due to the main lobe width and side lobes of the beam profile of the transmission ultrasonic waves can be reduced, thereby increasing the wireless power transmission efficiency of ultrasonic waves. This will be described in detail using experimental results of an embodiment of the present invention with reference to FIG. 5 to FIG. 10 below.

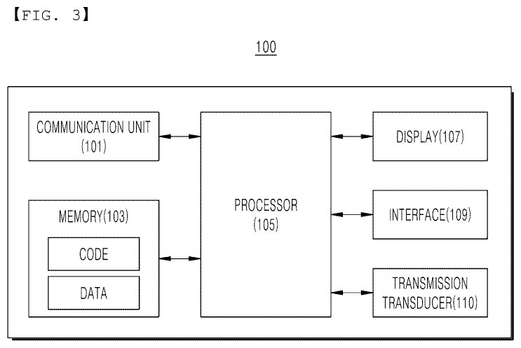

The wireless power transmission device 100 of the ultrasonic-based wireless power transmission system according to an embodiment of the present disclosure will be described with reference to FIG. 3.

In an embodiment, the wireless power transmission device 100 may include a communication unit 101 that performs communication with an external device, a memory 103 that stores a time delay when the transmission transducer 110 is composed of a plurality of array-type conversion elements and stores code for execution by a processor 105, a display 107 that displays a control result of the device, an event result of the device, or displays a power transmission status, an interface 109 for use by a peripheral device or a user, and the transmission transducer 110 that receives an electrical signal and generates transmission ultrasonic waves.

The wireless power transmission device 100 may include a converter/inverter that receives AC power from an external power supply and converts the same into DC power or vice versa, and may include an amplifier circuit that amplifies an electrical signal input from a power supply. The processor 105 may control the components and control the transmission transducer 110 to convert an electrical signal into transmission ultrasonic waves.

In an embodiment, the wireless power transmission device 100 may include a communication interface for performing communication with an external device.

The communication interface may include a wireless communication unit or a wired communication unit.

The wireless communication unit may include at least one of a mobile communication module, a wireless Internet module, a short-range communication module, and a location information module.

The mobile communication module transmits/receives a wireless signal to/from at least one of a base station, an external terminal, and a server on a mobile communication network constructed according to a communication method for mobile communication, such as Long Term Evolution (LTE).

The wireless Internet module is a module for wireless Internet access and may be built into the wireless power transmission device 100 or provided outside thereof, and a wireless LAN (WLAN), Wi-Fi, Wi-Fi Direct, Digital Living Network Alliance (DLNA), etc. may be used as the wireless Internet module.

The short-range communication module is a module for transmitting and receiving data through short-range communication, and may use Bluetooth (Bluetooth™), Radio Frequency Identification (RFID), Infrared Data Association (IrDA), Ultra Wideband (UWB), ZigBee, Near Field Communication (NFC), etc.

The location information module is a module for obtaining the location of the wireless power transmission device 100, and may be a global positioning system (GPS) module based on satellite navigation technology, or a module for obtaining a location based on wireless communication with a wireless communication base station or a wireless access point. The location information module may include a Wi-Fi module.

In an embodiment, the wireless power transmission device 100 may include an input unit or an output unit for user input.

The input unit may include a user interface (UI) including a microphone and a touch interface for receiving information from a user, and the user interface may include a mechanical or electronic interface implemented in the device as well as a mouse and a keyboard, and the method and form of the user interface are not particularly limited as long as a user instruction can be input thereto. The electronic interface includes a display capable of touch input.

The output unit is for displaying the output of the wireless power transmission device 100 to the outside to convey information to the user, and may include a display, an LED, a speaker, etc. for displaying visual output, auditory output, or tactile output.

The wireless power transmission device 100 may include a peripheral interface for data transmission/reception to/from various types of connected external devices, and may include a memory card port, an external device input/output (I/O) port, etc.

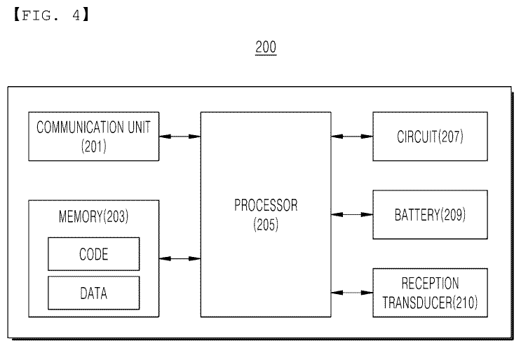

The configuration of the wireless power reception device 200 according to an embodiment of the present disclosure will be described with reference to FIG. 4. Detailed description of the same parts as those of the wireless power transmission device 100 described above with reference to FIG. 2 will be omitted.

In an embodiment, the wireless power reception device 200 may be an implantable medical device, such as an artificial pacemaker or a drug delivery system, or a component therein.

In an embodiment, the wireless power reception device 200 may include a communication unit 201 that performs communication with the wireless power transmission device 100 or an external device, a memory 203 that stores code for execution by a processor 205, a circuit 207 that performs an operation as an implant device or charges a battery 209 on the basis of an electrical signal generated based on transmission ultrasonic waves by the reception transducer 210, and the reception transducer 210 that receives transmission ultrasonic waves and generates an electrical signal.

Experimental results according to an embodiment of the present disclosure will be described with reference to FIG. 5 to FIG. 10.

Referring to FIG. 5, when the depth direction surface of the conversion element of the transmission transducer 110 that generates transmission ultrasonic waves has a curved surface as shown in FIG. 5(a) and operates at an operating frequency of 1 MHz, it is ascertained through simulation that a beam pattern as shown in FIG. 5(b) is present at a focusing point, which is the center of the radius of curvature of the curved surface. In addition, the actual beam pattern at the focusing point of the transmission ultrasonic waves generated by the conversion element of the transmission transducer 110 manufactured with the shape and dimensions as in FIG. 5(a) is as shown in FIG. 5(c).

That is, it is confirmed that the transmission ultrasonic waves generated by the transmission transducer 110 according to an embodiment of the present disclosure have a beam pattern that is longer in the lateral direction than in the elevation direction at the focusing point, and by designing the conversion element of the reception transducer 210 that is longer in the lateral direction than in the elevation direction to suit such a beam pattern, the wireless power transmission efficiency can be improved.

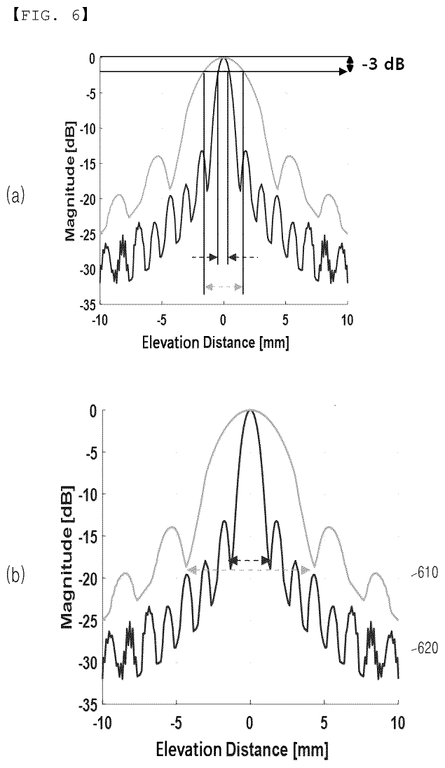

FIG. 6 illustrates beam profiles at the focusing point of the conversion element of the transmission transducer 110 that has a length of 35 mm in the elevation direction and curved surfaces in the depth direction whose centers of radii of curvature are 80 mm (610) and 35 mm (620).

The beam profiles at the focusing point of the conversion element of the transmission transducer 110 have elevation widths of 4 mm (611) and 1 mm (621) at a point of −3 dB from the highest sound pressure points of main lobes, and the entire elevation widths of the main lobes are elevation widths of 8 mm (613) and 2 mm (623).

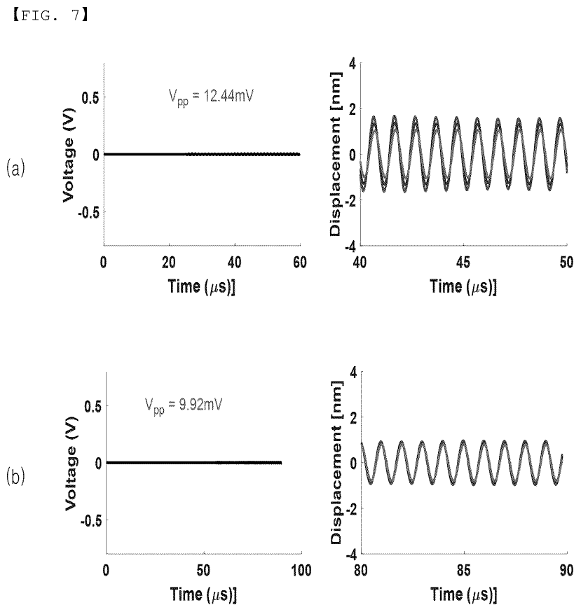

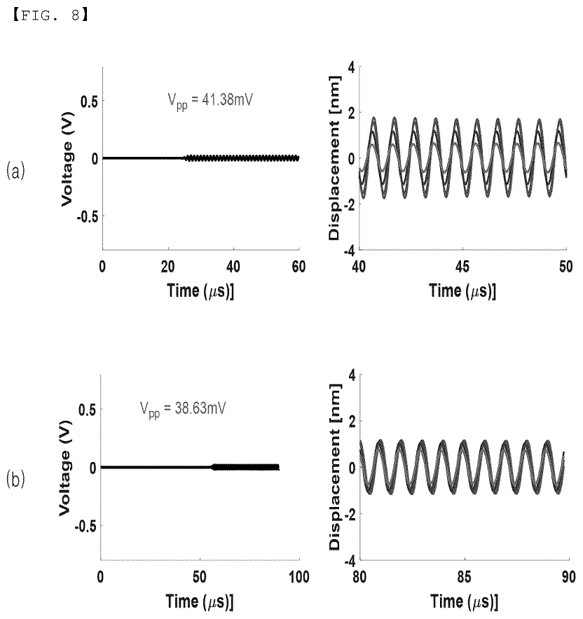

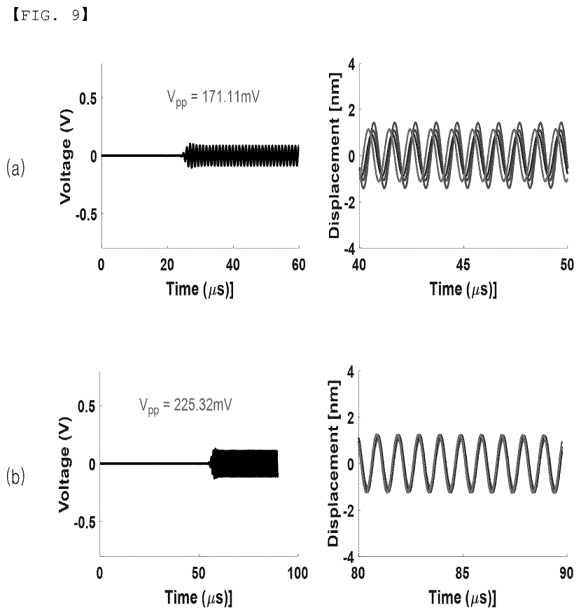

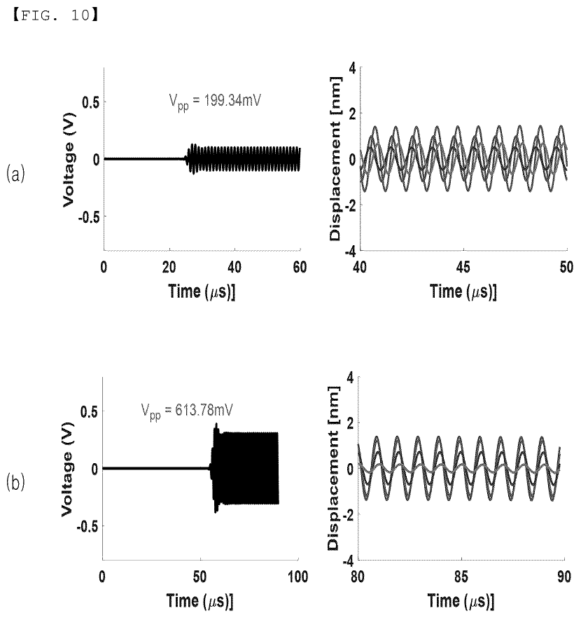

FIG. 7 to FIG. 10 illustrate voltages measured by the reception transducer 210 and vibrations in the conversion element of the reception transducer 210, which were observed while the elevation length of the reception transducer 210 having a lateral length longer than the elevation length as in FIG. 2 and a rectangular receiving plane of the conversion element facing the transmission transducer 110 was changed to 1 mm in FIG. 7, 2 mm in FIG. 8, 4 mm in FIGS. 9, and 8 mm in FIG. 10, in relation to the conversion element of the transmission transducer 110 having beam profiles shown in FIG. 6 and a curved surface with centers of radii of curvature of 80 mm (610) and 35 mm (620). The vibrations in the conversion element of the reception transducer 210 were observed at multiple points in the elevation direction of the conversion element. The left columns of FIG. 7 to FIG. 10 show voltages measured by the reception transducer 210, and the right columns of FIG. 7 to FIG. 10 show the vibrations observed at multiple points in the elevation direction of the conversion element of the reception transducer 210.

Referring to FIG. 7 to FIG. 10, when the length in the elevation direction of the reception transducer 210 is set to 2 mm (623), which is the entire width in the elevation direction of the main lobe of the beam profile of the transmission ultrasonic waves when the center of the curvature radius was 35 mm (620) (FIG. 8 (a)), it can be confirmed that the vibrations observed at multiple points in the elevation direction of the conversion element of the reception transducer 210 are consistent with each other and transmitted to the reception transducer 210 without wasting energy.

Referring to FIG. 7 to FIG. 10, when the length in the elevation direction of the reception transducer 210 is set to 8 mm (623), which is the entire width in the elevation direction of the main lobe of the beam profile of the transmission ultrasonic waves when the center of the radius of curvature is 80 mm (610) (FIG. 10 (b)), it can be confirmed that vibrations observed at multiple points in the elevation direction of the conversion element of the reception transducer 210 are consistent with each other and transmitted to the reception transducer 210 without wasting energy.

In addition, referring to FIG. 7 to FIG. 10, when the length in the elevation direction of the reception transducer 210 is set to 1 mm (623), which is a width of −3 dB in the elevation direction of the main lobe of the beam profile of the transmission ultrasonic waves when the center of the radius of curvature is 35 mm (620), it can be confirmed that vibrations observed at multiple points in the elevation direction of the conversion element of the reception transducer 210 are more consistent with each other than when the length in the elevation direction is 4 mm (FIG. 9 (a)) or 8 mm (FIG. 10 (a)), and are transmitted to the reception transducer 210 without wasting energy.

In addition, referring to FIG. 7 to FIG. 10, when the length in the elevation direction of the reception transducer 210 is set to 4 mm (623), which is a width of −3 dB in the elevation direction of the main lobe of the beam profile of the transmission ultrasonic waves when the center of the radius of curvature is 80 mm (610), it can be confirmed that vibrations observed at multiple points in the elevation direction of the conversion element of the reception transducer 210 are more consistent with each other than when the lateral length is 1 mm (FIG. 7 (b)) or 2 mm (FIG. 8 (b)), and are transmitted to the reception transducer 210 without wasting energy.

Therefore, it can be confirmed that optimal power transmission efficiency is obtained when the length in the elevation direction of the receiving plane of the reception transducer 210 is equal to or less than the entire width in the elevation direction of the main lobe of the beam profile at the focusing point of the transmission ultrasonic waves, and is equal to or greater than the width at the point of −3 dB from the highest sound pressure point of the main lobe in the elevation direction.

The simulation results are also the same for the relationship between the lateral length of the reception transducer 210 and the width of the lateral main lobe of the transmission beam profile by the transmission transducer 110, and therefore, in order to achieve optimal power transmission efficiency, the lateral length 111, the elevation length 113, and the curvature of the concave surface 115 in the depth-elevation direction of the transmission transducer 110 need to be determined such that the elevation length 213 and the lateral length 211 of the receiving plane of the reception transducer 210 are equal to or less than the entire width of the main lobe in the elevation direction and the lateral direction of the beam profile at the focusing point of the transmission ultrasonic waves, and are equal to or greater than the widths at points of −3 dB in the elevation direction and the lateral direction from the highest sound pressure point of the main lobe. Alternatively, the lateral length 211 and the elevation length 213 of the reception transducer 210 may be determined such that the receiving face of the reception transducer 210 is a plane, and the lengths are equal to or less than the entire width of the main lobe in the elevation direction and the lateral direction of the beam profile at the focusing point of the transmission ultrasonic waves, and equal to or greater than the widths at points of −3 dB in the elevation and lateral directions from the highest sound pressure point of the main lobe.

The present disclosure described above may be implemented as computer-readable code in a medium on which a program is recorded. A computer-readable medium includes all types of recording devices in which data readable by a computer system is stored. Examples of computer-readable medium include a hard disk drive (HDD), a solid state drive (SSD), a silicon disk drive (SDD), a ROM, a RAM, a CD-ROM, a magnetic tape, a floppy disk, an optical data storage device, etc. In addition, the computer may include the processor of each device.

Meanwhile, the program may be specially designed and configured for the present disclosure, or may be known and available to a person skilled in the art in the field of computer software. Examples of programs may include not only machine language code generated by a compiler but also high-level language code executable by a computer using an interpreter, etc.

In the specification (particularly, in the claims) of the present disclosure, use of the term “above” and similar referential terms may refer to both the singular and the plural. In addition, when a range is stated in the present disclosure, the statement includes the invention to which individual values within the range are applied (unless there is a statement to the contrary), and is the same as a statement of the individual values constituting the range in the detailed description of the invention.

Unless there is a statement of an explicit order or a statement to the contrary regarding steps constituting the method according to the present disclosure, the steps may be performed in any appropriate order. The present disclosure is not necessarily limited by the described order of the steps. Use of any examples or illustrative terms (for example, etc.) in the present disclosure is merely to describe the present disclosure in detail, and unless limited by the claims, the scope of the present disclosure is not limited by the examples or illustrative terms. Further, those skilled in the art will appreciate that various modifications, combinations, and changes may be made according to design conditions and factors within the scope of the appended claims or their equivalents.

Therefore, the spirit of the present disclosure should not be limited to the above-described embodiments, and the scope of the appended claims described below as well as all scopes equivalent to or equivalently changed from the claims are within the scope of the spirit of the present disclosure.

### INDUSTRIAL APPLICABILITY

The present invention relates to a method of transmitting power using ultrasonic waves as an energy transmission medium, and has high industrial applicability because it is possible to efficiently perform power transmission based on ultrasonic waves and reduce waste of transmission energy.

1. An ultrasonic-based power transmission system comprising:
a transmission transducer configured to receive an electrical signal and generate transmission ultrasonic waves; and
a reception transducer configured to receive the transmission ultrasonic waves generated by the transmission transducer and convert the transmission ultrasonic waves into an electrical signal,
wherein a conversion element of the reception transducer has a receiving plane where a receiving surface facing the transmission transducer is a plane, and the receiving plane has a shape corresponding to a shape of a beam profile generated by the transmission transducer at a focusing point.

2. The ultrasonic-based power transmission system of claim 1, wherein the receiving plane of the conversion element of the reception transducer has a shape in which a length in a lateral direction is greater than a length in an elevation direction.

3. The ultrasonic-based power transmission system of claim 1, wherein the reception transducer is an ultrasonic transducer composed of a single element.

4. The ultrasonic-based power transmission system of claim 1, wherein lengths of the receiving plane of the conversion element of the reception transducer in the lateral direction and the elevation direction are equal to or less than an entire width of a main lobe of a beam profile based on the lateral direction and the elevation direction at the focusing point of the transmission ultrasonic waves, and equal to or greater than a width at a point of −3 dB from a highest sound pressure point of the main lobe.

5. The ultrasonic-based power transmission system of claim 1, wherein a conversion element of the transmission transducer has a form in which a length in the lateral direction is greater than a length in the elevation direction, and has a concave shape in a depth direction in which the transmission ultrasonic waves are transmitted.

6. The ultrasonic-based power transmission system of claim 5, wherein the transmission transducer is an ultrasonic transducer composed of a single element.

7. The ultrasonic-based power transmission system of claim 5, wherein the transmission transducer is an ultrasonic transducer composed of a plurality of transmission elements,
wherein each of the transmission elements is controlled to generate an ultrasonic beam profile in which the length of the reception transducer in the lateral direction is equal to or less than an entire width of a main lobe of the beam profile at the focusing point of the transmission ultrasonic waves, and the length of the reception transducer in the elevation direction is equal to or greater than a width at a point of −3 dB from the highest sound pressure point of the main lobe.

8. An ultrasonic-based power reception device comprising:
a reception transducer configured to receive transmission ultrasonic waves generated by a transmission transducer configured to receive an electrical signal and generate the transmission ultrasonic waves, and convert the transmission ultrasonic waves into an electrical signal; and
a charging circuit configured to charge a battery based on the electrical signal,
wherein a conversion element of the reception transducer has a receiving plane where a receiving surface facing the transmission transducer is a plane, and the receiving plane has a shape corresponding to a shape of a beam profile generated by the transmission transducer at a focusing point.

9. The ultrasonic-based power reception device of claim 8, wherein the receiving plane of the conversion element of the reception transducer has a shape in which a length in a lateral direction is greater than a length in an elevation direction.

10. The ultrasonic-based power reception device of claim 9, wherein the reception transducer is an ultrasonic transducer composed of a single element.

11. The ultrasonic-based power reception device of claim 9, wherein the lengths of the receiving plane of the conversion element of the reception transducer in the lateral direction and the elevation direction are equal to or less than an entire width of a main lobe of the beam profile based on the lateral direction and the elevation direction at the focusing point of the transmission ultrasonic waves, and equal to or greater than a width at a point of −3 dB from the highest sound pressure point of the main lobe.
